(19) United States
(12) Patent Application Publication
(10) Pub. No.: US 2005/0177841 A1
(43) Pub. Date: Aug. 11, 2005

(54) Disk apparatus

(75) Inventor: Tadahiko Ichikawa, Onsen-gun (JP)

Correspondence Address: Parkhurst & Wendel, Suite 210, 1421 Prince Street, Alexandria, VA, 22314-2805, US

(73) Assignee: Matushita Elec. Ind. Co. Ltd., Kadoma-shi (JP)

(21) Appl. No.: 10/491,551

(22) PCT Filed: Apr. 2, 2003
(86) PCT No.: PCT/JP03/04299

(30) Foreign Application Priority Data
Apr. 10, 2002 (JP) 2002-107230

(51) Int. Cl. G11B 7/08; G11B 7/085; G11B 7/09

(52) U.S. Cl. 720/659

(57) ABSTRACT

Disks recorded in a same format are normally read at a same speed, even during playback of an audio video or the like, and during copying on a hard disk drive or the like. Because of this, when the reading speed is high, noise and vibration are caused to be large during playback, whereas when the reading speed is low, copying is caused to be slow. Hence, the present invention enables it to judge the read request interval issued by the host device to the disk drive in step S4, and to change the disk read speed in step S8 or step S12 by controlling the disk rotation speed according to the judgment. Consequently, noise and vibration are reduced during playback, and copying can be performed in a short time.

### TECHNICAL FIELD

The present invention relates to a disk drive that is employed by being connected to a host device, and, more specifically, to speed control of a disk drive that plays back information recorded on a disk that constitutes a medium for recording information.

### BACKGROUND ART

In the case of a system that connects and uses a host device and a disk drive, when data that can be played back at low speed such as audio or video data, or the like, recorded on a disk is played back, or when such data is saved to a hard disk drive or similar, a read command is issued by the host device to the disk drive and executed.

Normally, as long as a designation is not made by the host device and an error or similar does not occur, the speed at which data recorded in a certain format is read is implemented at a fixed speed that is determined by the disk drive. That is, the same speed is implemented both when sound and pictures are played back and when data is copied to a hard disk drive.

Furthermore, Japanese Patent Application Laid Open No. 2000-195143 discloses a method that measures, with a fixed interval serving as a unit, the usage rate of the buffer for temporarily storing data that is transferred between the disk drive and host device, and, on the basis of the measurement result, switches to the optimum power mode of two power modes, for example, whose electrical power consumption rates differ.

When audio or video data, or other data recorded on a disk is played back, a high-speed data transfer is not required and noise and vibrations must be reduced, whereas, when disk data is copied to a hard disk drive, or the like, a high-speed data transfer is required. However, the read command that is issued by the host device to the disk drive during playback and the read command that is issued by the host device to the disk drive during copying have the same content and hence playback and copying cannot be distinguished by the disk drive.

Accordingly, when the reading speed is high, noise and vibrations are large during playback, but when slow, there is the problem that copying is slow.

Furthermore, the technology disclosed by Japanese Patent Application Laid Open No. 2000-195143 employs a method which monitors a condition where the buffer is full and which, when the number of occasions that the buffer is full equals or exceeds a fixed number of occasions, switches the power mode. Therefore, when the buffer capacity is large, reading of a substantial number of blocks is required, and it will probably take a long time to change the rotation speed. Hence, it is probable that a state where audio or video, or the like, is played back while maintaining the high-speed rotation mode will prevail for a short while, and it will probably take time until high speed rotation mode is assumed during copying to the hard disk drive.

### DISCLOSURE OF THE INVENTION

An object of the present invention is to provide a disk drive with which the rotation speed of a disk will not rise higher than needed without exchanging special information between the host device and disk drive, and which spares a person playing back and listening to (and watching) an audio or video recording disk, a discomfort of noise and vibrations caused by disk rotation.

The disk drive of the present invention is a disk drive that is employed by being connected to a host device, comprising disk motor control means for controlling the disk rotation speed; playback means for reading disk information; interface means for exchanging information with the host device; and system control means for system-controlling each of these means, characterized in that the system control means are constituted to detect the frequency of use of the interface means and to change the disk reading speed by controlling the disk rotation speed in accordance with the state of the frequency of use of the interface means.

As a result of this constitution, the interval with which read commands are issued by the host device to the disk drive is such that read commands are issued continuously with barely any interval when copying to the hard disk drive of the host device is performed but issued with a certain interval when audio or video, or the like, is played back by the disk drive. Therefore, the interval for issuing the read commands is monitored, and because reading is performed at high speed if the interval is short and performed at low speed if the interval is long, copying can be performed within a short time, and noise and vibration can be reduced during playback. In addition, without being influenced by the capacity of the buffer in the disk drive, it is possible to rapidly change the rotation speed mode by measuring the number of occasions on which the buffer is full.

In addition, the disk drive is characterized in that the disk motor control means comprise at least two speed modes whose disk rotation speeds are different, and in that the system control means are constituted to change the disk reading speed by performing disk rotation speed control by changing the disk rotation speed to the optimum speed mode, in accordance with the state of frequency of use of the interface means.

As a result of this constitution, because an intermediate speed mode is provided in addition to the high speed rotation mode and the low speed rotation mode, the initial speed is set to the intermediate speed, the high speed rotation mode or low speed rotation mode is selected in accordance with the interval for issuing read commands, and, when a change is made from the high speed rotation mode to the low speed rotation mode, the reading temporary stoppage time resulting from the rotation speed change can be shortened via the intermediate speed mode.

In addition, the disk drive is characterized in that buffer means for temporarily storing data that is transferred to and from the host device is provided, and the system control means is constituted to measure the usage state of the buffer means, and to change the disk reading speed by controlling the disk rotation speed in accordance with the state of frequency of use of the interface means and with the usage state of the buffer means.

As a result of this constitution, a sound jump and picture disturbance during playback due to the rotation speed change can be prevented. For example, when the transition from the high speed rotation mode to the low speed rotation mode is made during audio or video playback, or the like, a period during which disk data is not read temporarily occurs, and, at this moment, if data stored in the buffer is not present, an immediate response to a request from the host device cannot be made. Accordingly, because, when the data held in the data storage means in the host device ceases to be played back, the data to be played back next is not present, a phenomenon such as a sound jump and picture disturbance occurs as a result. Therefore, with this temporary reading stoppage period caused by the rotation speed change in mind, a sound jump and picture disturbance during playback can be prevented by changing the rotation speed only when a certain fixed amount of data is stored in the buffer in the disk drive.

Furthermore, the disk drive is characterized in that the system control means is constituted to detect the number of read-request blocks from the host device by means of the interface means, and to change the disk reading speed by controlling the disk rotation speed in accordance with the state of frequency of use of the interface means and with the number of read-request blocks from the host device.

As a result of this constitution, where the read commands from the host device to the disk drive are concerned, it may be considered that the interval for issuing the read commands varies according to the size of the number of blocks requested all at once, and, in this case also, the data mount requested by the host device can be accurately grasped by seeking an interval which is calculated one block at a time. Therefore, the optimum reading speed can be implemented by controlling the rotation speed in accordance with the data amount.

Moreover, the disk drive is characterized in that data processing means, which analyzes contents of data read or to be read by the playback means, is provided, and that the system control means is constituted to change the disk reading speed by controlling the disk rotation speed in accordance with the state of frequency of use of the interface means only when the data is judged as an audio data or video data by the data processing means.

As a result of this constitution, this is effective in a case where there is no desire to perform a read operation in the low speed rotation mode with respect to data other than audio and video data, and so forth.

The disk drive rotation control method of the present invention is characterized by comprising, in executing copying or playback by passing data between a host device and a disk drive; changing disk reading speed by controlling the disk rotation speed of the disk drive in accordance with the state of frequency of use of an interface that exchanges information with the disk drive and the host device; and performing high speed reading when read commands are issued by the host device to the disk drive at short intervals, and performing low speed reading when the read commands are issued at long intervals.

The disk drive rotation control method of the present invention is characterized in that, when executing copying or playback by passing data between a host device and a disk drive, the disk reading speed is changed by controlling the disk rotation speed of the disk drive in accordance with the state of frequency of use of an interface that exchanges information with the disk drive and the host device, and with the usage state of buffer means that temporarily stores data that is transferred between the disk drive and the host device.

The disk drive rotation control method of the present invention is characterized in that, when executing copying or playback by passing data between the host device and the disk drive, the disk reading speed is changed by controlling the disk rotation speed of the disk drive in accordance with the state of frequency of use of an interface that exchanges information with the disk drive and the host device, and with the number of read-request blocks from the host device.

The disk drive rotation control method of the present invention is characterized in that, when executing copying or playback by passing data between a host device and a disk drive, contents of data read or to be read from a disk by playback means is analyzed, and the disk reading speed is changed by controlling the disk rotation speed in accordance with the state of frequency of use of an interface that exchanges information with the disk drive and the host device only when the data is judged as an audio data or video data.

The disk drive of the present invention is a disk device that is employed by being connected to a host device, comprising disk motor control means for controlling the disk rotation speed; playback means for reading disk information; interface means for exchanging information with the host device; and system control means for system-controlling each of these means, characterized in that the system control means is constituted to seek, from the interface means, an average time of intervals of read commands sent by the host device within a predetermined time period, to render a state of frequency of use of the interface means on the basis of the average time, and to change the disk reading speed by controlling the disk rotation speed in accordance with the frequency of use.

As a result of this constitution, because the objective is judged to be playback or copying on the basis of the average time of the intervals of the read commands sent by the host device within a predetermined time period even if the interval with which the read commands are issued by the host device to the disk device is irregular, speed control that is suited to the objective can be implemented without unnecessary speed changes.

Moreover, the disk drive is characterized in that the disk motor control means has at least two speed modes differing in disk rotation speed, and the system control means is constituted to change the disk reading speed by performing disk rotation speed control by changing the disk rotation speed to an optimum speed mode in accordance with the state of frequency of use of the interface means.

As a result of this constitution, even when the interval for issuing read commands by the host device to the disk device is irregular, because an intermediate speed mode is provided in addition to the high speed rotation mode and the low speed rotation mode, the initial speed is set to the intermediate speed mode. The high speed rotation mode or low speed rotation mode can be selected in accordance with the interval for issuing read commands, and, when a change is made from the high speed rotation mode to the low speed rotation mode, the reading temporary stoppage time resulting from the rotation speed change can also be shortened via the intermediate speed mode. Furthermore, also when a judgment of the frequency of use of interface means makes an intermediate selection between the high speed rotation mode and the low speed rotation mode, the current speed mode can be continued or the intermediate speed mode employed.

Further, the disk drive is characterized in that data processing means, which analyzes content of data read or to be read by the playback means, is provided, and that the system control means is constituted to change the disk reading speed by controlling the disk rotation speed in accordance with the state of frequency of use of the interface means only when the data is judged as an audio data or video data by the data processing means.

This constitution is effective when there is no desire to perform a read operation in the low speed rotation mode with respect to data other than audio and video data, and so forth. Furthermore, by making an audio/video distinction first all, whether it is a playback objective or copying objective can be judged with still higher precision.

The disk device rotation control method of the present invention is characterized in that, when executing copying or playback by passing data between a host device and a disk drive, an average time of intervals of read commands sent by the host device within a predetermined time period is sought from interface means that exchanges information with the disk drive and the host device; and the disk rotation speed is changed in accordance with the state of frequency of use of the interface means on the basis of the average time.

The disk device rotation control method of the present invention is characterized by comprising, when executing copying or playback by passing data between a host device and a disk drive, analyzing the contents of data read or to be read from a disk by playback means; implementing a processing routine in which when the data is judged as an audio data or video data, the average time of the intervals of the read commands sent by the host device within a predetermined time period is sought from the interface means that exchanges information with the disk drive and the host device; and changing the disk rotation speed in accordance with the state of frequency of use of the interface means on the basis of the average time. When the data is not judged as an audio data or video data, the processing routine to change the disk rotation speed is not implemented.

### BRIEF DESCRIPTION OF THE DRAWINGS

FIG. 1 is a constitutional view of the optical disk drive of the embodiments of the present invention;

FIG. 2 is a flowchart of the principal elements of the system controller of the optical disk drive of (the first embodiment of) the present invention;

FIG. 3 is a flowchart of the principal elements of the system controller of the optical disk drive of (the second embodiment of) the present invention;

FIG. 4 is a flowchart of the principal elements of the system controller of the optical disk drive of (the third embodiment of) the present invention;

FIG. 5 is a flowchart of the principal elements of the system controller of the optical disk drive of (the fourth embodiment of) the present invention;

FIG. 6 is a flowchart of the principal elements of the system controller of the optical disk drive of (the fifth embodiment of) the present invention; and

FIG. 7 is a flowchart of the principal elements of the system controller of the optical disk drive of (the sixth embodiment of) the present invention.

### BEST MODE FOR CARRYING OUT THE INVENTION

The disk drive of the present invention will be described below with reference to the drawings taking as an example a case where this disk drive is applied to an optical disk playback device.

### First Embodiment

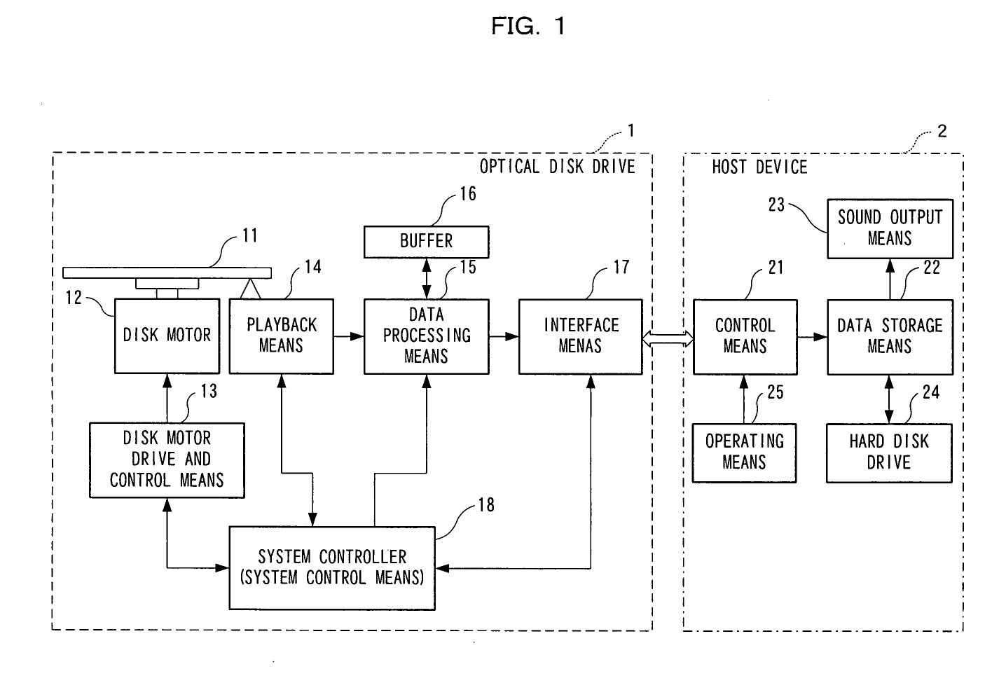

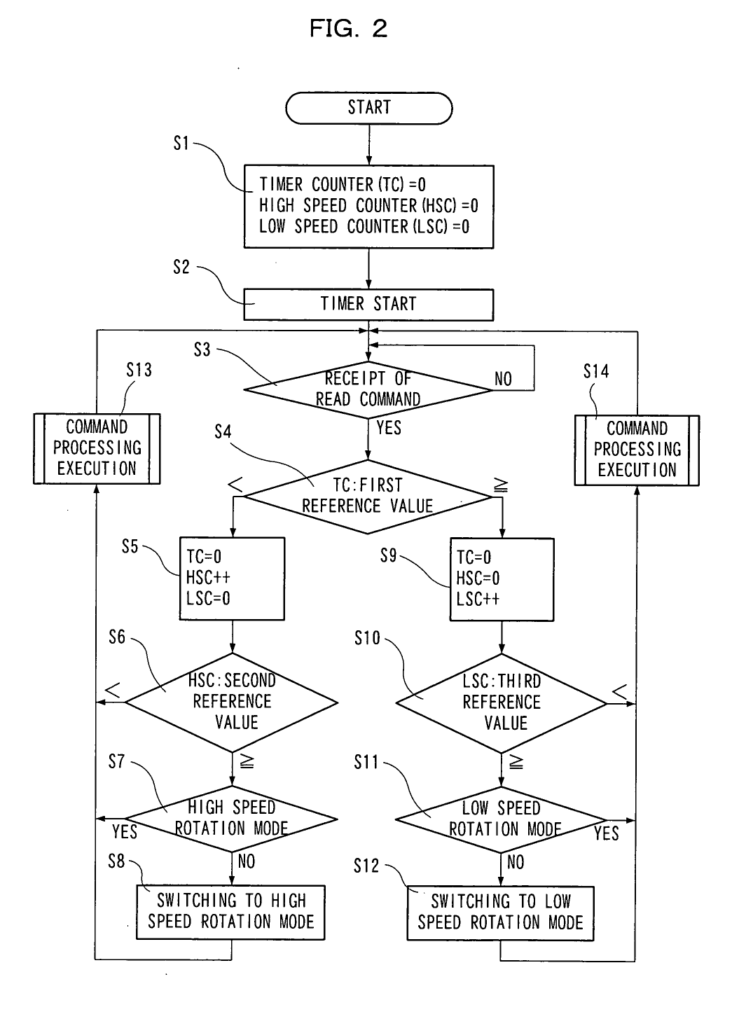

FIGS. 1 and 2 show the (first embodiment) of the present invention.

The operation of an optical disk drive 1 connected to a host device 2 via a transmission line 3 is controlled on the basis of a read command issued by the host device 2. As a specific example, the host device 2 is a personal computer main body, the optical disk drive 1 is a drive that is connected to the personal computer main body, and the host device 2 and the optical disk drive 1 may or may not be built into the same enclosure.

The optical disk drive 1, in which a disk 11 constituting a disk-shaped recording medium can be placed, drive-rotates the disk 11, which is placed by being introduced from the outside, by means of a disk motor 12. More specifically, this disk 11 is an optical disk, a magnetic disk, or a magneto-optical disk, or the like, for example.

The disk motor 12 is operated by disk motor drive and control means 13 which constitute disk motor control means. The disk motor drive and control means 13 receive a rotation command from a system controller 18 constituting system control means and cause the disk motor 12 to perform rotation, acceleration, deceleration, and stop operations, or the like, as per requirements.

Playback means 14 are constituted by an optical pickup, a magnetic head, and so forth, and by a head amplifier and signal processing circuit, for example, and subject the signal from the disk 11 to playback processing and send this signal to data processing means 15. A buffer 16 is connected to the data processing means 15. The output data of the data processing means 15 is transmitted to the host device 2 via interface means 17.

Furthermore, the data processing means 15 has a function that analyzes the content of the data read by the playback means 14 or the content of the data to be read thereby. More specifically, the data processing means 15 are capable of judging whether or not the data mode is an audio data mode or video data mode.

Further, the disk motor drive and control means 13 are equipped with a function to detect the rotational speed of the disk 11 and output this rotational speed to the system controller 18.

When the optical disk drive 1 receives a command from the host device 2 to transmit data which is recorded on the disk 11 to the host device 2 via the interface means 17, the data processing means 15 perform error correction and scramble analysis or other processing, for example, while temporarily storing data in the buffer 16, and transfer the processed data to the host device 2 via the interface means 17.

Next, the operation of the optical disk drive 1 and host device 2 will be described more specifically.

First of all, a case constituting a first example and in which an audio compact disk which is the disk 11 (referred to as a “CD” hereinafter) is played back will be described.

Methods for playing back an audio CD include a method that outputs sound from the optical disk drive 1 in accordance with a play command and a method according to which data that is transferred to the host device 2 in accordance with a read command is output as sound by the host device 2. However, the latter method will be described here.

The disk 11 is inserted in the optical disk drive 1, and when the user issues an audio CD playback command by means of a keyboard or mouse constituting operating means 25 of the host device 2, control means 21, these being specifically an operating system, application, driver, and interface, and so forth, request data from the optical disk drive 1 by means of an audio CD data read command.

Accordingly, the optical disk drive 1 transfers data to the host device 2 by using each of the means described above. The control means 21 store this data in data storage means 22 and output sound following an analog-signal conversion by means of a digital/analog converter (DAC) and a speaker, and so forth, which constitute sound output means 23.

Here, although the data amount required for sound playback of the audio CD is small at approximately 172 KB/second, because the capacity of the data storage means 22 in the host device 2 is limited, the control means 21 normally request data at a level satisfying the data amount required for playback. In other words, the read commands from the host device 2 to the optical disk drive 1 are issued at a certain intervals.

Further, during sound playback of an audio CD, because a high speed data transfer is not required and the noise caused by disk rotation is made as small as possible, the disk motor 12 and the disk motor drive and control means 13 are desirably controlled for a low rotational speed operation at a level where the sound is not broken.

As a second example, a description will be provided for a case where the data of the audio CD is copied and saved to a hard disk drive 24 of the host device 2.

When the disk 11 is mounted in the optical disk drive 1 and a command to save the data of the disk 11 to the hard disk drive 24 is output by the operating means 25, the control means 21 request data from the optical disk drive 1. Accordingly, the optical disk drive 1 transfers data to the host device 2 by using each of the means described above and the control means 21 save this data to the hard disk drive 24.

At such time, because there is no restriction on the playback speed as is the case during playback, in order to execute a copy operation at the highest speed possible, normally, read commands are mostly issued by the host device 2 to the optical disk drive 1 without intervals.

Further, when data is copied from the disk 11 to the hard disk drive 24, in order to make the waiting time interval for copying as short as possible, the system controller 18 controls the disk motor 12 and the disk motor drive and control means 13 for operation at a high speed rotational speed, whereby data is transferred at high speed.

As per the above two examples, in both a case where the host device 2 reads the data of the audio CD and sound is played back and output by the host device 2 and a case where the data of the audio CD is copied to the hard disk drive 24, a read command with the same content is issued by the host device 2 to the optical disk drive 1.

A description will be provided next for an embodiment of the present invention, which, in contrast, does not perform a special information exchange between the host device 2 and optical disk drive 1 and which, in correspondence with the optical disk drive 1 alone, performs suitable rotational speed control at which the rotational speed of the disk does not rise above that necessary.

In relation to this point, part of the system controller 18 is constituted to recognize the status of the read request from the host device 2 to the optical disk drive 1 by monitoring the information of the interface means 17, and switch the disk rotation speed in accordance with the frequency at which the system controller 18 issues the read command.

The constitution of this routine is shown in FIG. 2.

The system controller 18 contains a timer counter (hereinafter referred to as “TC”), a high speed counter for switching to high speed rotation mode (hereinafter referred to as “HSC”), a low speed counter for switching to low speed rotation mode (hereinafter referred to as “LSC”), and a timer.

First of all, the system controller 18 sets the “TC”, “HSC”, and “LSC” to an initial value 0 in step S1.

In step S2, the timer in the system controller 18 is operated and the “TC” is incremented by a certain fixed time interval by using the timer.

The interface means 17 monitor read commands from the host device 2 to the optical disk drive 1 and, upon detecting in step S3 that a read command has been received, compare the content of the “TC” with a first reference value in step S4.

The first reference value is determined by the interval between read commands issued by the host device 2.

For example, when audio or video data, or similar, is played back, normally, because a particularly high data transfer speed is not required, the frequency of the read command is small. That is, the interval for issuing the read command is comparatively long. On the other hand, when audio or video data, or similar, is saved to the hard disk drive 24 of the host device 2, a high speed data transfer is desirable and the read command frequency is high. In other words, the interval for issuing the read command is short. The first reference value may also be determined with these facts in mind.

In addition, when the interval between read commands issued normally is 100 milliseconds during playback of audio or video data and so forth, and is 10 milliseconds when such data is saved to the hard disk drive, for example, the first reference value may be determined such that the intermediate value is 50 milliseconds.

Also, for example, a time interval that is equal to or more than the time interval between the read commands normally issued and equal to or less than the time interval between the read commands issued during playback of audio or video data, or similar, may thus be determined for the first reference value.

The first reference value thus determined is pre-converted to a value that can be compared with the content of the “TC” and preset as a parameter within the system controller 18.

When the result of the comparison between the “TC” content and the first reference value is “TC<first reference value”, step S5 is executed to set the “TC” and “LSC” to “0” and increment the “HSC”, and, in step S6, the content of the HSC and a second reference value are compared.

Here, where the determination of the second reference value is concerned, when the interval at which the read command is issued by the host device 2 to the optical disk drive 1 remains short, that is, the number of occasions that is adequate to judge that copying from the disk 11 to the hard disk drive 24 is being executed is set as the second reference value.

When audio is played back, for example, because playback execution takes place once a fixed amount of data has been stored in the buffer of the host device 2, the read commands are initially issued with virtually no interval therebetween. Supposing the number of occasions on which this command is issued is 30, the second reference value may be determined as “50”, which is a number of occasions equal to or greater than 30.

Further, when audio is played back, for example, because playback execution takes place once a fixed amount of data has been stored in the buffer of the host device 2, the read commands are initially issued with virtually no interval therebetween. Accordingly, the number of commands that is issued by the host device 2 to the disk drive up until the amount of data cached in the buffer is equal to or more than a certain fixed amount may be the second reference value.

The second reference value thus determined is pre-converted to a value that can be compared with the HSC content, and preset as a parameter in the system controller 18.

The HSC content and the second reference value are compared in step S6 and, when “HSC<the second reference value”, once the command processing of the read command (step S13) has been executed, processing returns to step S3, and monitoring of read requests from the host device 2 to the optical disk drive 1 is resumed.

The HSC content and the second reference value are compared in step S6 and, when “HSC≦the second reference value”, step S7 is executed to check the current rotation mode. If operation in high speed rotation mode is in progress, the command processing of the read command (step S13) is executed, and then the processing returns to step S3 and, if operation in low speed rotation mode is in progress, switching to high speed rotation mode is performed in step S8 and then the command processing of the read command (step S13) is executed before returning to step S3.

In step S4, when “TC≧the first reference value”, step S9 is then executed to set the “TC” and “HSC” to “0” and increment the “LSC”. Then the LSC content and a third reference value are compared in step S10.

Here, where the determination of the third reference value is concerned, when the interval at which the read command is issued by the host device 2 to the optical disk drive 1 remains long, that is, the number of occasions that is adequate to judge that audio or video playback, or similar, is being executed by the host device 2 is set as the third reference value. The third reference value may be determined by using the same determination method as that for the second reference value and may be set as the same value, or may be a value that has been shifted by a certain amount.

The third reference value thus determined is pre-converted to a value that can be compared with the LSC, and preset as a parameter in the system controller 18.

The LSC content and the third reference value are compared in step S10 and, when “LSC<the third reference value”, once the command processing of the read command (step S14) has been executed, processing returns to step S3, and monitoring of read requests from the host device 2 to the optical disk drive 1 is resumed.

The LSC content and the third reference value are compared in step S10 and, when “LSC≧the third reference value”, step S11 is executed to check the current rotation mode. If operation in low speed rotation mode is in progress, the command processing of the read command (step S14) is executed, and then the processing returns to step S3 and, if operation in high speed rotation mode is in progress, switching to low speed rotation mode is performed in step S12 and then the command processing of the read command (step S14) is executed before returning to step S3.

Further, the LSC content is set to “0” in step S5 so that, when the read commands are occasionally issued at long intervals when the read commands from the host device 2 to the optical disk drive 1 are issued mostly at short intervals, a change to low speed rotation mode is not made in error. This is because, if the LSC content is not cleared to “0”, when the interval for issuing the read command is long at the rate of once in 100 occasions, for example, the LSC gradually increases such that when the condition “LSC≧the third reference value” is fulfilled, a switch is made to low speed rotation mode, and because, on the occasion of the next read command, the condition “HSC≧the second reference value” is immediately fulfilled and a switch is made to high speed rotation mode, unnecessary acceleration is implemented.

Accordingly, by clearing the “LSC” content to “0” in step S5, even in cases where read commands are issued at unexpectedly long intervals when high speed rotation mode continues, there is no unnecessary deceleration and it is possible to maintain a stable high speed rotation mode.

Similarly, the content of the “HSC” is set to “0” in step S9 so that, when the read commands are occasionally issued at short intervals when the read commands from the host device 2 to the optical disk drive 1 are issued mostly at long intervals, a change to high speed rotation mode is not made in error.

This is because, if the “HSC” content is not cleared to “0” in step 9, when the interval for issuing the read command is short at the rate of once in 100 occasions, for example, the content of the HSC gradually increases such that when the condition “HSC≧the second reference value” is fulfilled, a switch is made to high speed rotation mode, and because, on the occasion of the next read command, the condition “LSC≧the third reference value” is immediately fulfilled and a switch is made to low speed rotation mode, unnecessary acceleration is implemented.

Accordingly, because the content of the “HSC” is cleared to “0” in step S9, even in cases where read commands are issued at unexpectedly short intervals when low speed rotation mode continues, there is no unnecessary acceleration and hence it is possible to maintain a stable low speed rotation mode and spare the user the discomfort of noise and vibration.

The high and low speed rotation modes referred to here are the rotational speeds of the disk 11. Both a case where each mode is controlled to the respective specified rotational speeds during high speed rotation and low speed rotation, and a case where control is performed such that the high speed rotation mode is in place at speeds equal to or more than a specified rotational speed and the low speed rotation mode is in place at speeds equal to or less than a specified rotational speed are possible. The high speed rotation mode can also be controlled from a specified rotational speed to a specified rotational speed or more, and the low speed rotation mode can also be controlled from a specified rotational speed that is different from the specified rotational speed of the high speed rotation mode to a corresponding specified rotational speed or more.

Current disk drives are generally thin “slim type” disk drives built into notebook computers and so forth and half height-type disk drives that are built into desktop computers, and these disk drives also differ in size, quality and structure. The rotational speed of the low speed mode and the rotational speed of the high speed mode, and so forth, as defined by the present invention vary according to whether the disk drive type is the thin slim type or half height type.

Here, where the low speed rotation mode is concerned, because the fact that the vibration and noise levels differ widely according to the mechanical parts of the disk drive, the rotational speed range in which vibrations and noise are effectively absorbed is desirably determined from experimental results.

Current experimental results are such that, for example, in the case of thin slim-type disk drives built into notebook computers and so forth, 1200 to 2600 rpm (revolutions per minute) is appropriate in low speed rotation mode and 3400 to 5200 rpm is appropriate in high speed rotation mode. In the case of the half height type built into desktop computers, 1200 to 4300 rpm is appropriate in low speed rotation mode and 5100 to 10000 rpm is appropriate in high speed rotation mode.

Further, modes are not limited to the two modes of high speed rotation and low speed rotation. A second reference value and a third reference value may be provided stepwise and the speed may be varied stepwise by the numerical values of “HSC” and “LSC”.

### Second Embodiment

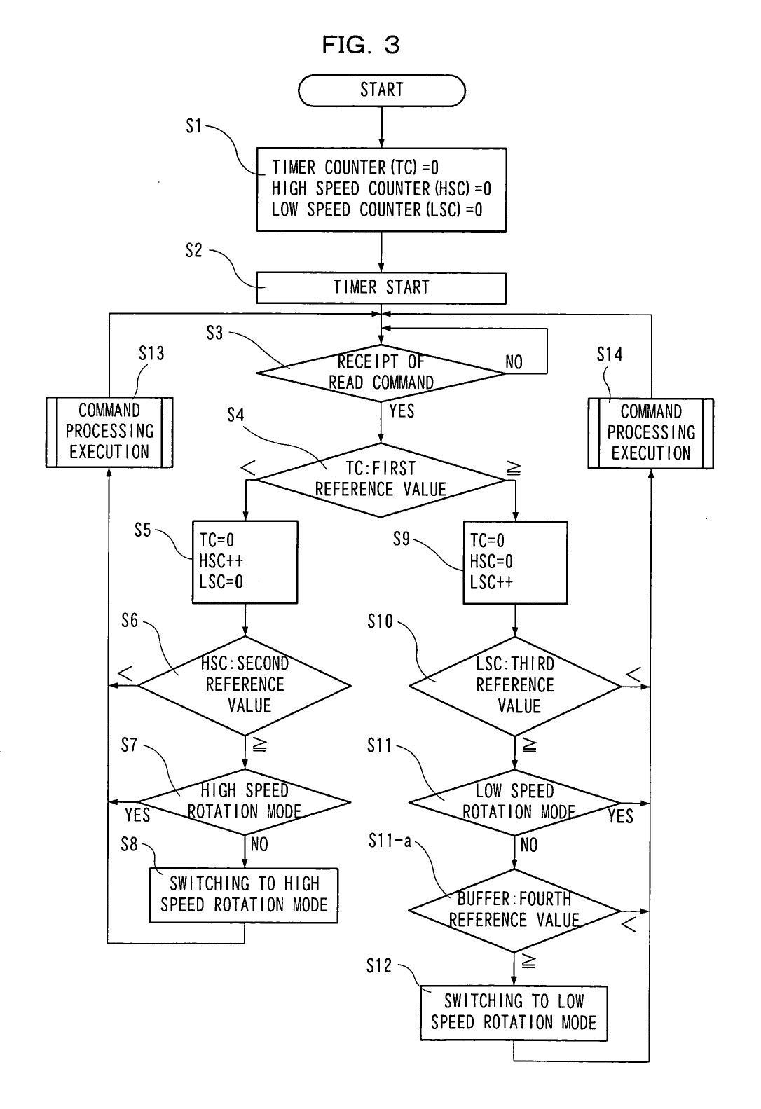

FIG. 3 shows the (second embodiment) of the present invention.

In FIG. 2, which shows the (first embodiment), when the system controller 18 judges in step S11 that the low speed rotation mode is not in place, step S12 is immediately executed. However, the (second embodiment) differs only in the fact that same is constituted such that, when it is judged in step S11 that the low speed rotation mode is not in place as shown in FIG. 3, step S11-a is executed prior to step S12.

The provision of step S11-a makes it possible to prevent breaking up of the sound and picture, and so forth, by making a switch from the high speed rotation mode to the low speed rotation mode during audio or video playback, or similar, of the disk 11 which is placed in the optical disk drive 1.

To describe this in more detail, when the rotation mode is switched, it is normally necessary to stop once the operation of reading from the disk 11. Accordingly, when data of a fixed amount is not stored in the buffer upon switching from the high speed rotation mode to the low speed rotation mode during audio and video playback and so forth, a phenomenon where the sound is broken during audio playback and the sound and picture and so forth are broken during video playback will probably occur. For this reason, when a switch from the high speed rotation mode to the low speed rotation mode is made during audio and video playback and so forth, the rotation mode is desirably changed once data equal to or more than the fixed amount has been secured in the buffer.

That is, when it is judged in step S11 shown in FIG. 3 that the current mode is not the low speed rotation mode, step S11-a is executed instead of immediately executing step S12.

In step S11-a, the number of data blocks stored in the buffer 16 and the fourth reference value are compared, and if the number of blocks in the buffer≧a fourth reference value, a switch to the low speed rotation mode is made in step S12. The fourth reference value is determined by means of the disk read stoppage time interval that results from the rotational mode switch.

For example, although data of 75 blocks per second is required in order to play back CD audio sound, supposing that the disk read stoppage time interval that results from the rotational mode switch is one second, if data of 75 blocks or more is present in the buffer, a sound jump or other problems are not generated, and hence the fourth reference value may be determined to be “75”.

In addition, for example, the fourth reference value may represent a state where required disk data is stored in the buffer to an extent where playback of disk data by the host device 2 is not stopped during the time interval during which reading from the disk 11 is stopped due to rotation mode switching. The fourth reference value which is thus determined is preset as a parameter in the system controller 18.

### Third Embodiment

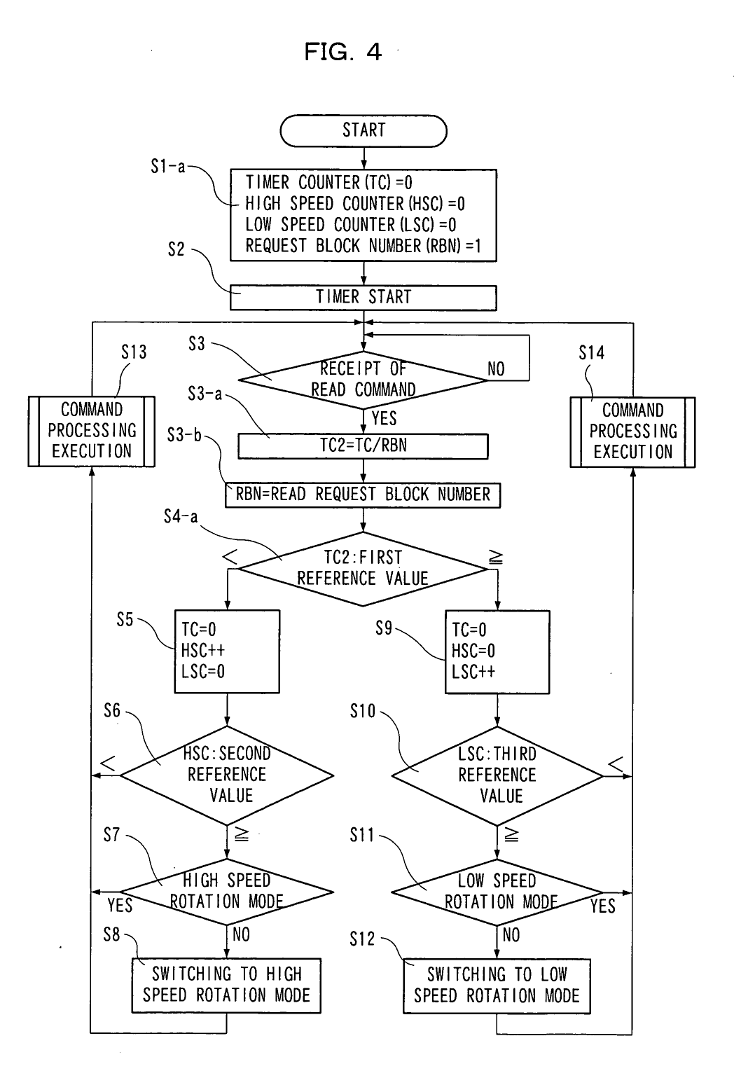

FIG. 4 shows the (third embodiment) of the present invention.

This embodiment differs only in the fact that steps S1 and S4 in FIG. 2 which show the (first embodiment) are changed to steps S1-a and S4-a and that steps S3-a and S3-b are inserted between steps S3 and S4.

As a result of this variation, the time interval for converting the interval between the read commands from the host device into units of 1 block is known and more accurate rotational control can be performed irrespective of the number of request blocks.

Describing this in more detail, the read command issued by the host device 2 to the optical disk drive 1 normally requests a plurality of blocks at once, and hence control that considers the number of request blocks in addition to the interval between read commands is performed by the system controller 18 in this (third embodiment).

In step S1-a of FIG. 4, in addition to the initialization of “TC”, “HSC”, and “LSC”, the content of a register (RBN) for storing the number of request blocks is initialized to “1”.

Further, after passing via step S2, in step S3-a, TC2=TC/RBN is calculated, and the number of blocks requested by the read command is saved in the “RBN” in step S3-b.

That is, the number of request blocks is temporarily saved every time a read command is received, and when the next read command is received, the number of blocks is determined from the number of blocks requested by the read command received on the previous occasion as well as from the content of the “TC” and then written to a “TC2”.

In step S4-a, the content of the “TC2” and the first reference value are compared and, depending on the result, processing branches off to step S5 or step S9.

Here, the reason the previous number of request blocks is used is that the amount of data that is transferred from the optical disk drive 1 to the host device 2 varies depending on the size of the number of request blocks, and hence the time interval up until the host device 2 issues the next read command is then different.

As a result, the time interval during which the interval between the read commands from the host device is converted into units of one block is known and more accurate rotational control can be performed irrespective of the number of request blocks.

For example, in a case where audio playback, or the like, in which the number of request blocks of the read command is one block is performed, the command interval is probably short, whereas, in a case where copying to a hard disk drive with the number of request blocks is 1000 blocks at a time, the command interval probably increases due to the time taken up by the processing in the host device.

For this reason, a switch to the low speed rotation mode can be performed when the high speed rotation mode is to be maintained, or vice versa, and hence this has the effect of preventing erroneous switching of the high speed switching mode.

### Fourth Embodiment

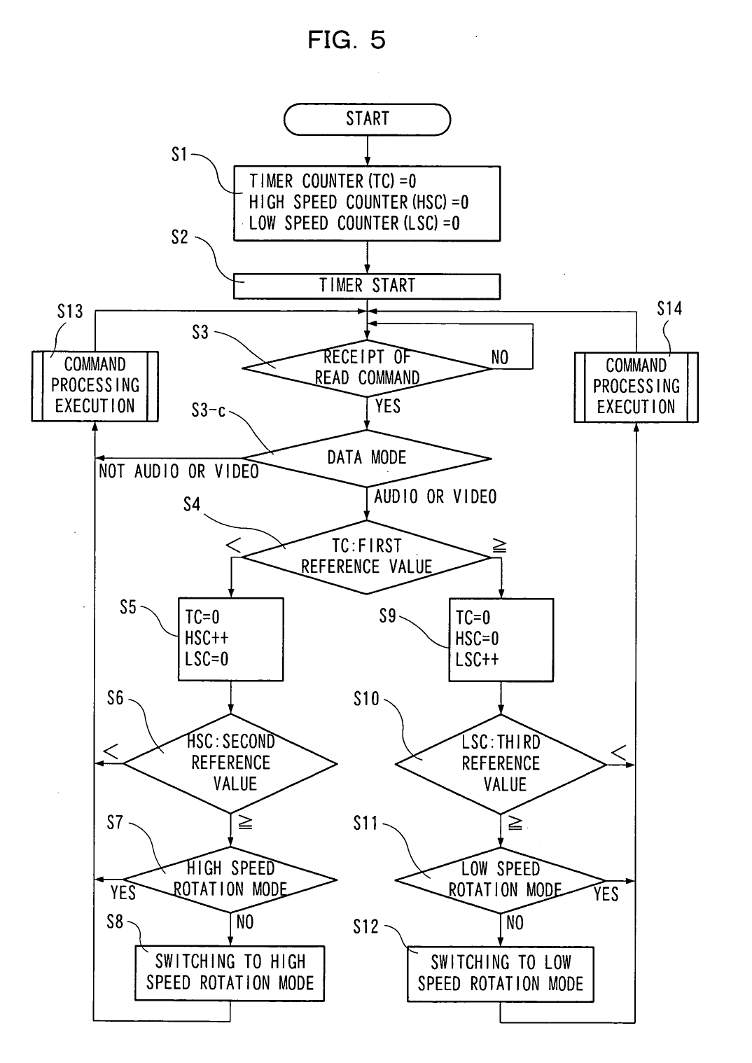

FIG. 5 shows the (fourth embodiment) of the present invention.

In FIG. 2 that shows the (first embodiment), when the system controller 18 judges in step S3 that a read command has been received, step S4 is immediately executed. However, the (fourth embodiment) differs only in that same is constituted such that, when it is judged in step S3 that the read command has been received as shown in FIG. 5, step S3-c is executed prior to step S4.

As a result of this variation, the disk reading speed can be changed by controlling the disk rotation speed in accordance with the state of the frequency of use of the interface means only when it is judged that the data is an audio data or video data.

Describing this in more detail, when a read command is received in step S3, the system controller 18 checks, in step S3-c, the distinction judgment of the data processing means 15 which analyze the data read by the playback means 14. When it is judged that the data currently being read is audio or video data, or the like, the processing branches off to step S4 and the processing to judge the switching of the rotational speed mode is resumed. If the data is different data, the processing branches off to step S3 and the processing to judge the switching of the rotational speed mode is not performed.

Here, a description will be provided for a method in which the data processing means 15 judge the data to be audio or video data, or the like.

For example, in the case of an optical disk such as a CD (Compact Disk), information that is obtained from the disk 11 by the playback means 14 in the spin-up processing when the disk is mounted is converted into TOC (Table of Contents) information by the data processing means 15, and, based on this information, the system controller 18 is able to judge that this is an audio disk.

Alternatively, in the case of an optical disk such as a CD (Compact Disk), when a read command has been issued by the host device 2, the playback means 14 read data on the disk 11 at the requested address and this data is converted by the data processing means 15 into header information for subcode Q channel or main channel data, or other information, and, based on this information, the system controller 18 is able to judge that this is audio or video data.

Alternatively, in the case of an optical disk such as a CD (Compact Disk), when a read command has been issued by the host device 2, the playback means 14 read data on the disk 11 at the requested address and the SYNC (sync signal) pattern for the main channel data is detected by the data processing means 15. In the absence of the SYNC (sync signal) pattern, audio data can be judged if a bit indicating a subcode Q channel data track is 0.

Otherwise, in the case of an optical disk such as a CD (Compact Disk), when a read command has been issued by the host device 2, the playback means 14 read data on the disk 11 at the requested address and the SYNC (sync signal) pattern for the main channel data is detected by the data processing means 15. When the SYNC (sync signal) pattern is present, the data mode of the main channel data is mode 2 form 2, and if a bit indicating video of the submode byte of the subheader has been set, it can be judged that video data is recorded.

Alternatively, in the case of an optical disk such as a CD or DVD (Digital Versatile Disk), the spin-up processing when the disk is mounted, or when directory information and file information and so forth of the file system is read in accordance with a read command from the host device 2, if information that indicates a disk recorded with video, such as, in the case of a CD, a file called “INFO.VCD”, “ENTRIES. VCD”, or, in the case of a DVD, a file called “VIDEO_TS.IFO” is present, for example, video data can be judged.

Alternatively, in the case of an optical disk such as a CD or DVD, or the like, when a read command has been issued by the host device 2, before the playback means 14 read the data on the optical disk at the requested address, a search for information recorded with directory information and so forth from the disk 11 is performed, and the information obtained by the playback means 14 is processed by the data processing means 15, and, on the basis of this information, the system controller 18 is able to make an audio disk or video data judgment.

### Fifth Embodiment

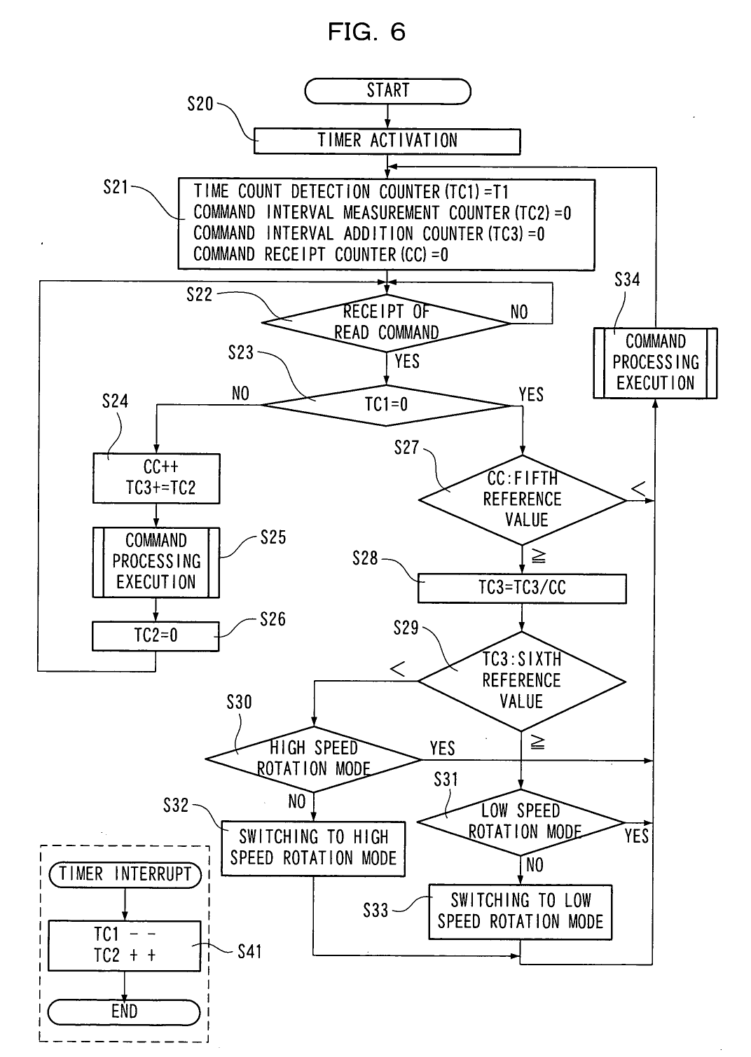

FIG. 6 shows the (fifth embodiment) of the present invention.

The system controller 18 contains a timer counter (hereinafter referred to as “TC1”) for detecting timeout, a timer counter for measuring the intervals of each of the commands (hereinafter referred to as “TC2”), a counter for adding up the intervals of each of the commands until timeout (hereinafter referred to as “TC3”), and a counter for adding up the number of occasions a command is received (hereinafter referred to as “CC”).

First of all, the system controller 18 activates the timer in the system controller in step S20. The timer is caused by a program to generate an interrupt for each predetermined time period, and, in step S41, the value of “TC1” is “−1”, and the value of “TC2” is +1”. The system controller 18 is able to determine the elapsed time interval by reading the “TC1” and “TC2”.

In step S21, in order to calculate the predetermined time period, a value that permits a time interval to be counted by means of the timer interrupts is set as “T1”. “TC2”, “TC3”, and “CC” are set to the initial value “0”.

Here, the interval between the read commands issued by the host device 2 to the optical disk drive 1 also varies according to the environment of the host device 2 and the application used, and so forth, and cases where the objective of playback or the copying objective is hard to judge reliably from the interval for issuing the read commands may be considered. For example, when a state in which four of five read commands are issued at short intervals but a read command is issued once at a long interval prevails, or when, conversely, four of five read commands are issued at long intervals but a read command is issued once at a short interval prevails.

Here too, in order to judge whether the objective is playback or copying, implementation involves monitoring the command intervals that fall within the time interval “T1”, which is comparatively long in comparison with the command interval, and then finding the average value of these command intervals.

When the value of time interval “T1” is too short, it is possible that an excessive speed change will be performed due to a judgment error. On the other hand, when the value of the time interval “T1” is too long, it is possible that the change from the high speed rotation to low speed rotation will not be made during playback.

Accordingly, in view of these facts, the value of the time interval “T1” is assigned a predetermined value that indicates an appropriate time interval for reliably judging whether the objective is playback or copying.

For example, normally, when audio playback is started, because playback execution takes place once a fixed amount of data has been stored in the buffer of the host device 2, the read commands are initially issued with virtually no interval therebetween, and because there may then be the data amount required for audio playback, a read command is issued with a certain time interval. As an example of this, in a case where twenty initial read commands are issued at one millisecond intervals and then at 200 millisecond intervals, the average threshold value of the command intervals for judging the objective as being playback or copying is 100 milliseconds. When a calculation is performed to determine how many 200-millisecond-interval commands must be issued for a value that is close to the threshold value, given.

(1 millisecond×20 times+200 milliseconds×N times)/(20+N)=100 milliseconds, the above equation is satisfied when the value of N is approximately 20. Accordingly,

1 millisecond×20 times+200 milliseconds×20 times=4020 milliseconds, and therefore, where the value of the time interval “T1” is concerned, a value that is larger than 4020 milliseconds and approximately 5 seconds may be determined as the value of “T1”.

The interface means 17 monitor the read commands from the host device 2 to the optical disk drive 1, and, in step S22, judge whether or not a read command has been received. When the interface means 17 detect that a read command has been received in step S22, step S23 is executed.

In step S23, the interface means 17 check whether or not “TC1” is “0”, and, if not “0”, the processing moves on to step S24, whereupon “CC” is incremented by “+1” and “TC2” is added to the “TC3”. Then, once the command processing for the read command has been executed (step S25), “TC2” is cleared to “0” in step S26 and the processing returns to step S22. In other words, “TC2” indicates the time interval from when a read command ends and the next read command is issued, and the “TC3” represents the sum total of the command intervals until the timeout of “TC1”.

When “TC1=0” in step S23, step S27 is executed and “CC” and a fifth reference value are compared. The number of commands issued within the time interval “T1” is considered and is a value determined beforehand.

Hence, when commands are issued at high speed on only a number of initial occasions within the time interval “T1” and then no commands are issued for example, this is not targeted for speed switching in order to prevent the possibility of a playback judgment when copying is actually being executed.

In addition, it may be considered that, of the numbers of occasions on which a command is issued during playback and copying respectively within a certain fixed time interval, the number of occasions on which a command is issued during playback is smaller. Therefore, when the number of occasions on which a command is issued during playback is considered, supposing that the time interval “T1” is 5 seconds and the time interval for issuing read commands during playback is 200 milliseconds, commands are issued 5 seconds/200 milliseconds=25 times, and hence the fifth reference value may be determined to be a value which is smaller than 25 and which represents 15 to 20 times.

In step S27, when, as a result of comparing the content of “CC” and the fifth reference value, “CC≧the fifth reference value”, step S28 is executed and the result of the calculation “TC3/CC” is assigned to the “TC3”. This serves to determine the average time of a single command interval within the time interval “T1”.

Next, “TC3” and a sixth reference value are compared in step S29. Here, the sixth reference value is a value determined beforehand by considering the time intervals of the read commands issued during playback and copying. For example, supposing that the time interval for the read commands from the host device 2 to the optical disk drive 1 is 200 milliseconds during playback and one millisecond during copying, where the sixth reference value is concerned, a value between these two values that represents 50 to 100 milliseconds may be determined as the sixth reference value.

When, as a result of comparing the content of “TC3” and the sixth reference value, “TC3<the sixth reference value”, the objective is judged as copying because the time interval for issuing commands is short, and the processing moves on to step S30.

In step S30, it is judged whether or not the high speed rotation mode is in place. If the current rotation mode is the high speed rotation mode, the command processing is executed in step S34 and then the processing returns to step S21.

When it is judged in step S30 that the rotation mode is not the high speed rotation mode, step S32 is executed. Switching to the high speed rotation mode is performed in step S32 and then command processing is executed in step S34, whereupon the processing returns to step S21.

In step S29, when, as a result of comparing the content of “TC3” and the sixth reference value, “TC3≧the sixth reference value”, the objective is judged to be playback because the time interval for issuing commands is long. The processing then moves on to step S31.

In step S31, it is judged whether or not the rotation mode is the low speed rotation mode. If the current rotation mode is the low speed rotation mode, command processing is executed in step S34 and then the processing returns to step S21. If the rotation mode is not the low speed rotation mode, switching to the low speed rotation mode is performed in step S33 and then command processing is executed in step S34, whereupon the processing returns to step S21.

Here, the condition for a transition to either the high speed rotation mode or the low speed rotation mode depends on the value of “TC3”, with the sixth reference value serving as the threshold value. However, by providing a seventh reference value separately from the sixth reference value such that “the sixth reference value<the seventh reference value”, when “TC3<the sixth reference value”, the objective is judged to be copying because the interval for issuing the commands is short, and hence a transition to the high speed rotation mode is made. When “TC3≧the seventh reference value”, the objective is judged to be playback because the interval for issuing the commands is long, and hence a transition to the low speed rotation mode is made. When “the sixth reference value<TC3<the seventh reference value”, because the judgment of a playback objective or copying objective is difficult, a method that maintains the current speed can also be adopted.

Accordingly, although is may be considered that the interval for issuing the read commands issued by the host device 2 to the optical disk drive 1 also varies according to the environment of the host device 2 and the application used, and so forth, unnecessary speed changes are not made even when the command intervals are irregular, speed control that is matched to the amount of data required by the host device 2 is possible, and the user is spared the discomfort of noise and vibration.

### Sixth Embodiment

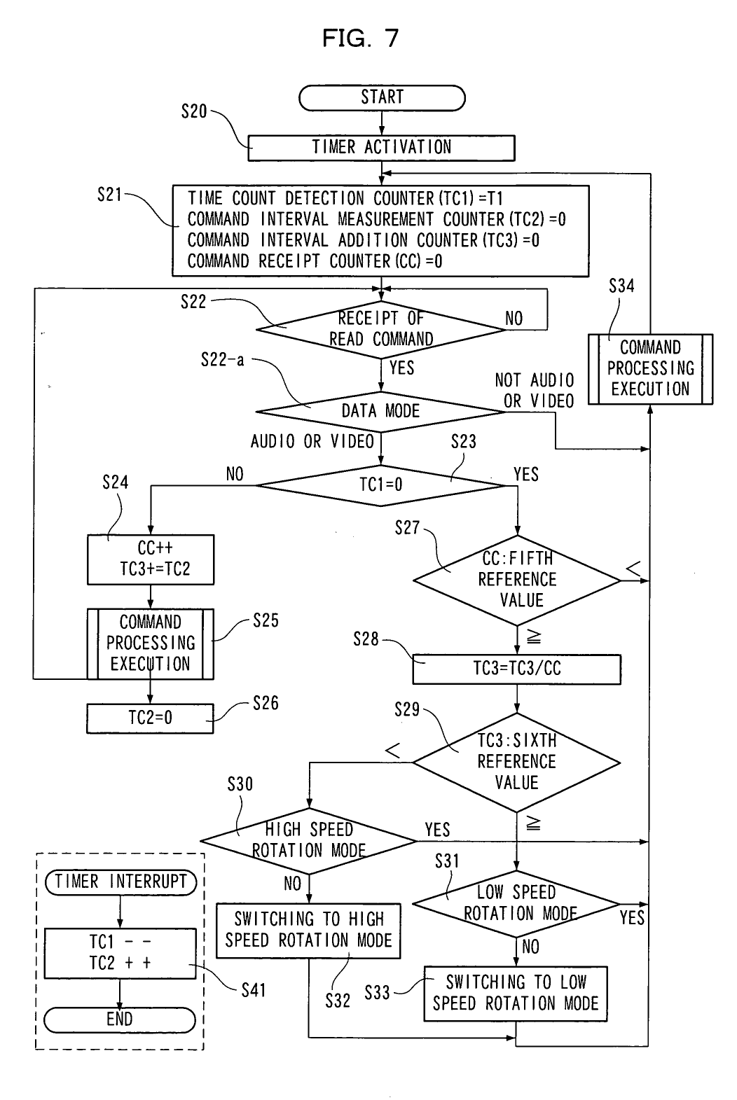

FIG. 7 shows the (sixth embodiment) of the present invention.

In FIG. 6, which shows the (fifth embodiment), when the system controller 18 judges in step S22 that a read command has been received, step S23 is immediately executed. However, as shown in FIG. 7, the (sixth embodiment) differs in the fact that same is constituted such that, when it is detected in step S22 that a read command has been received, step S22-a is executed prior to step S23, the processing routine (steps S23 to S33) is implemented only when an audio data or video data judgment has been made, and the processing routine (steps S23 to S33) for a disk rotation speed change is not implemented when an audio data or video data judgment has not been made.

As a result of this variation, the disk reading speed can be changed by controlling the disk rotation speed in accordance with the state of the frequency of use of the interface means only when an audio data or video data judgment has been made.

Describing this in more detail, when it is detected that a read command has been received in step S22, the system controller 18 checks, in step S22-a, the distinction judgment of the data processing means 15 which analyze the data read by the playback means 14. When it is detected that the data currently being read is “audio or video” data, or the like, processing for a rotation speed mode switching judgment is resumed by executing step S23. When it is detected that the data is not “audio or video” data, or the like, in step S22-a, the command processing of step S34 is executed and then the processing returns to step S21, the processing for a rotation speed mode switching judgment not being performed.

The method whereby the data processing means 15 judge the data to be audio or video data, or similar, was described in the (fourth embodiment) and is therefore omitted here.

This is therefore effective in a case where normal rotation control is performed without a drop in the rotation speed when data that is not audio or video data, or similar, is read.

Further, although audio and video data, and so forth, was described in each of the embodiments described above, the present invention is not limited to audio and video data and can be applied to all data. In addition, an optical disk playback device was described, but the present invention can be applied to all recording/playback devices that play back information by using various disks, such as an optical disk recording/playback device, a magnetic disk drive, a magneto-optical disk drive, and so forth.

According to the disk drive of the present invention as described above, special information exchange between the host device and disk drive is not performed; in correspondence with the disk drive alone, control of the disk rotation speed that corresponds with the frequency with which the host device requests data can be performed; control of the disk rotation speed that corresponds with the type of data requested by the host device can be performed; the objective of a request by the host device can be judged to be playback or copying and the corresponding disk rotation speed control performed even when the frequency of the host device requests is irregular; the disk rotation speed does not rise above that required and the person playing back and listening to (and watching) the audio or video recording disk are spared the discomfort of noise and vibrations caused by disk rotation.

In short, when a high speed data transfer is unnecessary, a read operation is performed by switching to the low speed rotation mode. More particularly, during audio and video playback, and so forth, a high speed data transfer is not required and hence, by performing the operation in the low speed rotation mode, noise, vibration, and so forth, caused by disk rotation can be suppressed as far as possible.

Moreover, when a high speed data transfer is required, a read operation is executed by switching to the high speed rotation mode. Particularly when copying data on a disk to a hard disk drive in the host device, a reduction of the copying time can be achieved by reading at high speed.

1. A disk drive that is employed by being connected to a host device, comprising:
disk motor control means for controlling disk rotation speed;
playback means for reading disk information;
interface means for exchanging information with the host device; and
system control means for system-controlling each of said means,
wherein the system control means is constituted to detect frequency of use of the interface means and change the disk reading speed by controlling the disk rotation speed according to the state of frequency of use of the interface means.

2. The disk drive as set forth in claim 1, wherein the disk motor control means has at least two speed modes differing in disk rotation speed, and the system control means is constituted to change the disk reading speed by performing disk rotation speed control by changing the disk rotation speed to an optimum speed mode, according to the state of frequency of use of the interface means.

3. The disk drive as set forth in claim 1, further comprising buffer means for temporarily storing data that is transferred to and from the host device, whereby the system control means measures a usage state of the buffer means, and changes the disk reading speed by controlling the disk rotation speed according to the state of frequency of use of the interface means and the usage state of the buffer means.

4. The disk drive as set forth in claim 1, wherein the system control means is constituted to detect the number of read-request blocks from the host device by means of the interface means, and change the disk reading speed by controlling the disk rotation speed according to the state of frequency of use of the interface means and the number of read-request blocks from the host device.

5. The disk drive as set forth in claim 1, further comprising data processing means for analyzing contents of data read or to be read by the playback means, whereby the system control means changes the disk reading speed by controlling the disk rotation speed according to the state of frequency of use of the interface means, only when the data is judged as audio data or video data by the data processing means.

6. A disk drive rotation control method, comprising, in executing copying or playback by passing data between a host device and a disk drive:
changing disk reading speed by controlling disk rotation speed of the disk drive according to a state of frequency of use of an interface for exchanging information with the disk drive and the host device; and
performing high speed reading when read commands are issued by the host device to the disk drive at short intervals, and performing low speed reading when the read commands are issued at long intervals.

7. A disk drive rotation control method, comprising, in executing copying or playback by passing data between a host device and a disk drive:
changing disk reading speed by controlling disk rotation speed of the disk drive according to a state of frequency of use of an interface for exchanging information with the disk drive and the host device, and a usage state of buffer means for temporarily storing data that is transferred between the disk drive and the host device.

8. A disk drive rotation control method, comprising, in executing copying or playback by passing data between a host device and a disk drive:
changing disk reading speed by controlling disk rotation speed of the disk drive according to a state of frequency of use of an interface for exchanging information with the disk drive and the host device, and the number of read-request blocks from the host device.

9. A disk drive rotation control method, comprising, in executing copying or playback by passing data between a host device and a disk drive:
analyzing contents of data read or to be read from a disk by playback means; and
changing disk reading speed by controlling disk rotation speed according to a state of frequency of use of an interface for exchanging information with the disk drive and the host device, only when the data is judged as audio data or video data.

10. A disk drive that is employed by being connected to a host device, comprising:
disk motor control means for controlling the disk rotation speed;
playback means for reading disk information;
interface means for exchanging information with the host device; and
system control means for system-controlling each of the means,
wherein the system control means is constituted to seek, from the interface means, an average time of intervals of read commands sent by the host device within a predetermined time period, to render a state of frequency of use of the interface means on a basis of the average time, and change disk reading speed by controlling the disk rotation speed according to the frequency of use.

11. The disk drive as set forth in claim 10, wherein the disk motor control means has at least two speed modes differing in disk rotation speed, and the system control means is constituted to change the disk reading speed by performing disk rotation speed control by changing the disk rotation speed to an optimum speed mode, according to the state of frequency of use of the interface means.

12. The disk drive as set forth in claim 10, further comprising data processing means for analyzing contents of data read or to be read by the playback means, whereby the system control means changes the disk reading speed by controlling the disk rotation speed according to the state of frequency of use of the interface means, only when the data is judged as audio data or video data by the data processing means.

13. A disk drive rotation control method, comprising, in executing copying or playback by passing data between a host device and a disk drive:
seeking, from interface means for exchanging information with the disk drive and the host device, an average time of intervals of read commands sent by the host device within a predetermined time period;
changing disk rotation speed according to a state of frequency of use of the interface means, on a basis of the average time; and
performing high speed reading when read commands are issued from the host device to the disk drive at short intervals, and performing low speed reading when the read commands are issued at long intervals.

14. A disk drive rotation control method, comprising, in executing copying or playback by passing data between a host device and a disk drive:
analyzing contents of data read or to be read from a disk by playback means;
when the data is judged as audio data or video data, implementing a processing routine,
the routine comprising
seeking, from interface means for exchanging information with the disk drive and the host device, an average time of intervals of read commands sent by the host device within predetermined time period, and
changing disk rotation speed according to a state of frequency of use of the interface means on a basis of the average time, whereby high speed reading is performed when read commands are issued from the host device to the disk drive at short intervals and low speed reading is performed when the read commands are issued at long intervals; and
when the data is not judged as audio data or video data, implementing no processing routine to change the disk rotation speed.
